(19) United States
(12) Patent Application Publication
(10) Pub. No.: US 2017/0330078 A1
(43) Pub. Date: Nov. 16, 2017

(54) METHOD AND SYSTEM FOR AUTOMATED MODEL BUILDING

(71) Applicant: ASHOK REDDY, CLARKSBURG, MD (US)

(72) Inventor: PRAVEEN KODURU, THE WOODLANDS, TX (US)

(73) Assignee: ASHOK REDDY, CLARKSBURG, MD (US)

(21) Appl. No.: 15/652,281

(22) Filed: Jul. 18, 2017

(51) Int. Cl. G06N 3/12; G06N 99/00

(52) U.S. Cl. CPC G06N 3/126; G06N 99/005

(57) ABSTRACT

The various embodiments herein provide a method and system for automated model building, validation and selection of best performing models. The method comprises of selecting a dataset available for modeling from one or more external data sources, dividing the dataset into at least three parts, selecting one or more modeling methods along with associated parameters ranges based on the model to be built, identifying one or more fitness functions against which the models need to be evaluated, generating a plurality of model building experiment variation that can be run utilizing a first part of the dataset, obtaining values of the fitness function for the different modeling method experiments on the first part of the dataset, obtaining a second fitness value by re-evaluating the generated models from the different experiments on a second part of the dataset to evaluate the model performance on unseen data during training, selecting, one or more best performing models by comparing the first fitness value and the second fitness value, generating fitness values by an algorithm processing module using selected one or more best performing models on the remaining datasets, and selecting the best model from the conducted evaluation.

### FIELD OF TECHNOLOGY

The present disclosure generally relates to model building systems and methods and particularly relates to a method and system for automated model building, validation and selection of best performing models.

### BACKGROUND

Conventional model building techniques involve using training data and generating a model based on the patterns learned from the training data utilizing a cost function that is designed to minimize the error in predictions. The model is then validated using testing data to measure the accuracy of the models performance on data not utilized during training process. This ensures the model is generalized enough and is not over-fitted on training data.

As a part of the standard model building process the following steps are typically followed:
1. Defining problem to be solved;
2. Preparation of necessary data;
3. Identifying parameters required for performance measurement;
4. Defining fitness functions and expected baseline performance;
5. Identifying different modeling methods and their variants, wherein variants can also be determined based on changes in input data; and
6. Running models on testing datasets and selecting the best model among the selected models as a feasible solution.

One of the major challenges in this process is the sheer volume of permutations and combinations available from a decision making point of view. Some of the factors that influence the output include, but not limited to, number of input data fields, different selected modeling methods, various parameters used to iterate the model performance like number of trees in a decision tree modeling method, performance parameters like prediction accuracy, precision, recall etc. and the like.

Based on the herein abovementioned steps and parameters considered, identifying an optimum solution becomes a very challenging task and hence the scientist/modeler will be left with lot of work and data to deal with. In such cases, identifying the optimum or best model will also depend on the experience and expertise of the scientist/modeler. With new faster computational machines and the adoption of Parallel/Cluster computing for modeling, it is now possible to compute many variants of models in a distributed fashion in a much shorter time. The current emphasis has been mostly towards using large amounts of data to generate better models, which may or may not provide the best model that explains the inherent patterns in the provided data. Additionally, such models based on large data could also be either black box/complex to enable easier interpretation of patterns generated by the models.

Currently different modeling techniques are used to generate trained models based on the methods utilized and various inherent parameter selections, which are selective to each method. It is a well-known fact that not one method is sufficient to provide a good model in most of the problems and hence the data modeler/scientist is faced with the problem to implement multiple modeling methods for every problem, assess the performance and relatively quantify the accuracy of the output and select the best performing modeling method. The search becomes even more complicated when the modeling methods are sensitive to the training data quality, distributions, method parameters that can affect final performance.

Furthermore, it is expected that if a generated training model is a closer approximation of the global optima, then performance metrics will be similar in both training and testing data evaluations. However, most conventional learning methods could easily generate over trained models, and hence have a low generalization due to over learning of training data set. Such generated trained models could easily underperform on testing data.

In order to minimize the errors caused due to over generalization or over learning on training data set, multiple different techniques such as, but not limited to, cross validation, bagging, boosting, ensemble learning, early stopping, and the like are used. However, not all modeling methods/algorithms are conducive to implement this kind of strategy.

In view of the foregoing, there is a need to provide a method and system using which a user can select the data for training and testing, along with a set of usable modeling methods that can be used to build multiple models and let the method run a search to identify the best possible model and its related parameters that provide the best generalization and hence a much closer approximation to global optima. Further, there is a need to provide a method and system that validates the generated models against data not utilized in training and testing of the models and generate a better ranking of models based on performance metrics to enable easier best performing model selection.

The above mentioned shortcomings, disadvantages and problems are addressed herein and which will be understood by reading and studying the following specification.

### SUMMARY

The primary objective of the embodiments herein is to provide a method and system for automated model building, validation and selection of best performing models.

Another objective of the embodiments herein is to provide a method and system using which a user can select the data for training and testing, along with a set of usable modeling methods that can be used to build multiple models and let the method run a search to identify the best possible model and its related parameters that provide the best generalization and hence a much closer approximation to global optima.

Another objective of the embodiments herein is to provide a method and system that validates the generated models against data not utilized in training and testing of the models and generate a ranking of models based on performance metrics to enable easier best performing model selection.

According to an embodiment herein, the method for automated model building, validation and selection of best performing models is described herein. The method comprises steps of selecting a dataset available for modeling from one or more external data sources, and dividing the dataset into at least three parts, wherein the dataset is obtained by merging data from one or more external data sources using a database connector module. Further, the method comprises of selecting one or more algorithms/modeling methods along with associated parameters ranges based on the model to be built.

Further, the method comprises step of generating a plurality of model building experiment variation that can be run utilizing a first part of the dataset. Further, the method comprises of obtaining a value of a fitness function for the models by running different modeling method experiments on the first part of the dataset and evaluating their final performance for each of the runs. Further, the method comprises of obtaining the value of a second, same or different fitness function by running the generated models on the second part of the dataset. Further, the method comprises of selecting one or more best performing models by comparing the first fitness value and the second fitness value. Further, the method comprises of obtaining the value of the same or different fitness function by running the one or more best performing models on the remaining part of the dataset. Further, the method comprises of selecting the best model by comparing the values of the various fitness functions generated.

According to an embodiment herein, the first part of the dataset is the training data, the second part of the dataset is the testing data, and the third and more parts of the dataset is the validation data.

According to an embodiment herein, the model is selected using Pareto front. According to another embodiment herein, selecting the model is iteratively performed on plurality of models to obtain one or more best performing models.

According to an embodiment herein, a system for automated model building, validation and selection of best performing models is described herein. The system comprises of a database connector module that creates a dataset by receiving data from one or more external data sources and merging them, a data extraction module that selects the dataset available for modeling from one or more external data sources, a data preparation module that processes the raw data for modeling based on requirements, a data management module that selects and divides the dataset of prepared data into at least three parts, an algorithm management module adapted for selecting one or more algorithms/modeling methods based on the model to be built, generating a plurality of model building experiment variation that can be run utilizing the first part of the dataset, a parameter design module adapted for defining a fitness function and for defining ranges of parameters for the selected modeling methods as well as input data parameters, an algorithm processing module to obtain the fitness value for the models on the first part of the dataset after running different modeling method experiments on the first part of the dataset and evaluating their final performance for each of the runs, obtaining a second fitness value for the same or different fitness function by running the generated models on the second part of the dataset to evaluate the performance on unseen data during training, a model validation and selection module adapted for selecting one or more best performing models by comparing the first fitness value and the second fitness value, further, obtaining the value of the same of different fitness function for the one or more best performing selected models by the algorithm processing module using the remaining part of the dataset, evaluating the one or more best performing selected models by comparing the various fitness functions using the model validation and selection module to select the best model.

According to another embodiment herein, a system for automated model building, validation and selection of best performing models is described herein. The system comprises of a database connector module that creates a dataset by receiving data from one or more external data sources and merging them, a data extraction module that selects the dataset available for modeling from one or more external data sources, a data preparation module that processes the raw data for modeling based on the requirements, a data management module that selects and divides the dataset of the prepared data into at least three parts, an algorithm management module adapted for selecting one or more algorithms/modeling methods based on the model to be built, generating a plurality of model building experiment variation that can be run utilizing the various parts of the dataset, a parameter design module adapted for defining fitness functions and for defining ranges of parameters for the selected modeling methods as well as input data parameters. An algorithm processing module to obtain the value of the defined fitness functions for the various datasets after running different modeling method experiments on the various parts of the datasets and evaluating their final performance for each of the runs, a model validation and selection module adapted for selecting one or more best performing models by comparing the values of the various fitness functions in phases.

According to another embodiment of the present invention, one or more computer-readable media having computer-usable instructions stored thereon for performing a method of selecting automated models, the method comprising steps of selecting, by a data extraction module, a dataset available for modeling from one or more external data sources, preparing, the data for modeling by processing the raw data as per requirements, by the data preparation module, dividing, by a data management module, the dataset of the prepared data into at least three parts, selecting, by an algorithm management module, one or more modeling methods based on the model to be built, a plurality of model building experiment variation that can be run utilizing a first part of the dataset, defining, by the parameter design module, fitness function and ranges of parameters for the selected modeling methods as well as input data parameters, obtaining, by an algorithm processing module, a fitness function the value of which is obtained by running different modeling method experiments on the first part of the dataset and evaluating their final performance for each of the runs, obtaining, by the algorithm processing module, a second fitness value for the same or different fitness function by running the generated models from the different experiments on the second part of the dataset to evaluate the performance on unseen data during training, selecting, by a model validation and selection module, one or more best performing models by comparing the first fitness value and the second fitness value, obtaining, by the algorithm processing module, a fitness value(s) using the same or different fitness function for the one or more best performing models on the remaining part(s) of the dataset to evaluate the performance on unseen data during training and testing, evaluating, by a model validation and selection module, one or more best performing models by comparing the fitness function (s) obtained by running the models on the different parts of the dataset, and selecting best model from the conducted evaluation.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a flowchart illustrating a method for automated model building, validation and selection of best performing models, according to an embodiment herein.

FIG. 2 is an exemplary illustration of process flow in the method for automated model building, validation and selection of best performing models, according to an embodiment herein.

FIG. 3 is a schematic diagram illustrating a use case of plotting fitness functions of two more models over Pareto front for evaluation, according to an embodiment herein.

FIG. 4 is a block diagram illustrating a system for automated model building, validation and selection of best performing models, according to an embodiment herein.

Although specific features of the present invention are shown in some drawings and not in others. This is done for convenience only as each feature may be combined with any or all of the other features in accordance with the present invention.

### DETAILED DESCRIPTION OF THE EMBODIMENTS

The present invention provides a method and system for automated model building, validation and selection of best performing models. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The present invention describes selecting one or more models for a dataset, and identifying the model that can be the best solution for the dataset, wherein the model is selected based on comparison of different corresponding parameters of other models.

According to an embodiment of the present invention, for the automated model building, validation and selection of best performing models comprises steps of selecting a dataset available for modeling from one or more external data sources, and dividing the dataset into at least three parts, wherein the dataset is obtained by merging data from one or more external data sources using a database connector module. Further, the method comprises of selecting one or more algorithms/modeling methods along with associated parameter ranges based on the model to be built. Further, the method comprises step of generating a plurality of model building experiment variation that can be run utilizing a first part of the dataset.

Further, the method comprises of obtaining the value of the designed fitness function by running different modeling method experiments on the first part of the dataset. Further, the method comprises of obtaining the value of either the same or different fitness function by running the generated models on the second part of the dataset to evaluate the models on unseen data during training. Further, the method comprises of selecting one or more best performing models by comparing the first fitness value and the second fitness value. Further, the method comprises of obtaining the value of the same of different fitness function by running the one or more best performing models on the remaining part of the dataset. Further, the method comprises of comparing the values of the various fitness functions to select the best model from the conducted evaluation.

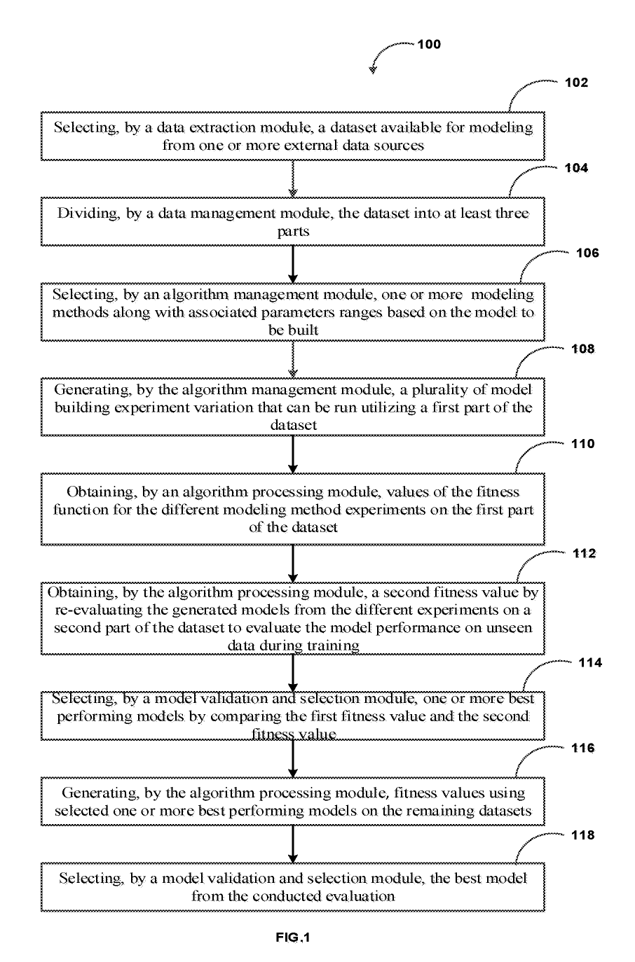

FIG. 1 is a flowchart 100 illustrating a method for automated model building, validation and selection of best performing models, according to an embodiment herein. According to FIG. 1, at step 102, the method comprises of selecting a dataset available for modeling from one or more external data sources. One or more external data sources are connected to the system. A data extraction module of the system receives the data from the one or more data sources and thus forms a single dataset for modeling.

Further, at step 104, the method comprises dividing the dataset into at least three parts, wherein the dataset is obtained by merging data from one or more external data sources using a database connector module. The dataset obtained from the data extraction module can be divided into three or more Parts (p₁, p₂, p₃, . . . , pₙ), wherein the first part of the dataset (p₁) is training data, the second part of the dataset (p₂) is testing data, and the third and consecutive parts of the dataset (p₃, p₄, . . . pₙ) comprises of the validation data. The user can define division of the dataset based on the user requirement. In another embodiment of the present invention, the dataset can be divided uniformly into three or more parts. According to the present invention, upon dividing the dataset, there shall be no similar data points across any of the part of the dataset.

Further, at step 106, the method comprises selecting one or more modeling methods along with associated parameters ranges based on the models to be built. Any number of different modeling methods can be selected for the selected dataset as long as they can be all assessed with same fitness function on each of the different datasets. The fitness functions for each of the datasets can be independent of each other. Hence, the user can define different fitness functions for each of the datasets. In an embodiment of the present invention, each model can be a single model built using a modeling technique/method or can be combination of one or more modeling methods such as mixture of models, without departing from the scope of the invention.

Further, at step 108, the method comprises of generating a plurality of model building experiment variations that can be run utilizing a first part of the dataset (p₁). In an embodiment of the present invention, models are defined as a combination of, but not limited to, modeling methods and its relevant parameters, first part of the input dataset (p₁), variables used to build the model from (p₁), and the like, without departing from the scope of the invention.

Further, at step 110, the method comprises of obtaining a fitness value (f₁) for the first part of the dataset (p₁) by running different modeling method experiments on the first part of the dataset (p₁) and evaluating their final performance for each of the runs. Multiple models can be built using the same training data set (p₁). Selection of the dataset can be done on the input dataset to exclude some of the samples and/or variables to generate different variants for the same modeling technique. This enables identification of noisy data and/or variable importance for generating good models.

Further, at step 112, the method comprises of obtaining a second fitness value (f₂) by re-evaluating the generated models from the different experiments on a second part of the dataset (p₂) to evaluate the fitness on unseen data during training. Here, same selected one or more models are run on second part of the dataset (p₂), which is testing data. In an embodiment of the present invention, the steps 110 and 112 of obtaining first and second fitness values for the first and second parts of dataset can be performed iteratively for plurality of models, without departing from the scope of the invention.

Further, at step 114, the method comprises of selecting one or more best performing models by comparing the first fitness value (f₁) and the second fitness value (f₂) using the model validation and selection module. The best performing models are selected using the Pareto front, wherein the selected models are representative population of best generalization to the data set provided.

Further, at step 116, the method comprises performing evaluation of the selected one or more best performing models using remaining dataset (p₃, p₄, . . . pₙ) to generate values of the same or different fitness function (f₂, f₃, . . . fₙ). Earlier, the evaluation is performed on only first and second part of the dataset (p₁, p₂). Thus, evaluation can be performed on the remaining part of the dataset, which is validation data, for selecting one or more best performing models using Pareto front. Further, at step 118, the method comprises of selecting the best model from the conducted evaluation.

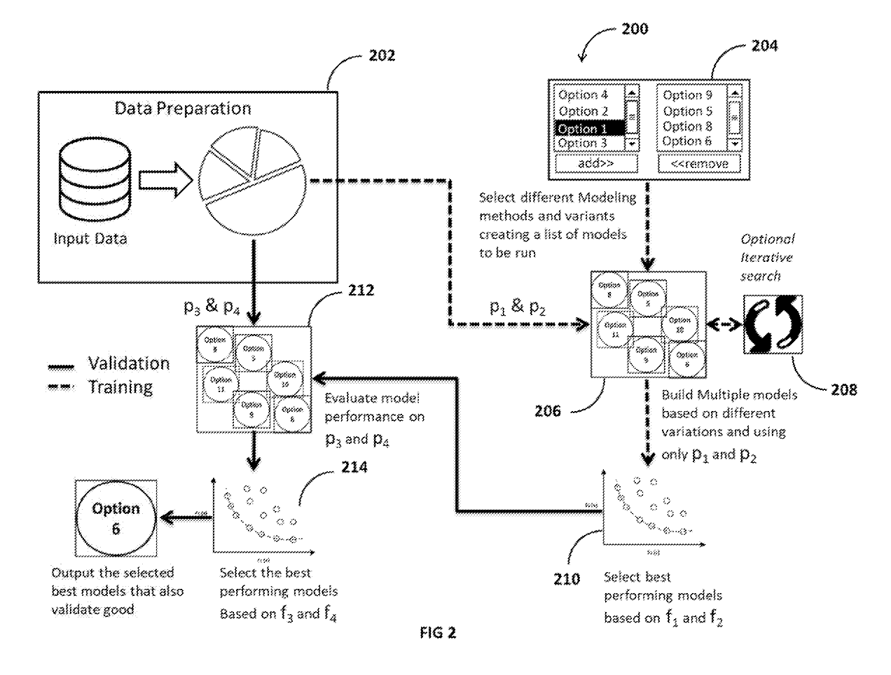

FIG. 2 is an exemplary illustration of process flow 200 in the method for automated model building, validation and selection of best performing models, according to an embodiment herein. The process flow 200 is described seven steps, where based on the selected dataset one or more best performing models can be selected using automated model building technique. According to the present method, at step 202, data is prepared, wherein a dataset is selected for modeling and divided into four parts p₁, p₂, p₃ and p₄. The user can define the division of the dataset into these parts, and the dataset can be divided by default into even parts. The four datasets do not comprise of similar data points.

At step 204, one or more modeling methods and their associated parameters and variants are selected based on the model to be built. Thus a list of modeling methods is obtained that need to be run on the first part of the dataset (p₁). Further, at step 206, different modeling method experiments are run on first part of the dataset (p₁) and their final performance for each of the runs can be evaluated. The evaluated fitness's obtained is stored as (f₁) Further, the generated models from the different experiments can be re-evaluated on second part of dataset (p₂) to evaluate the fitness on unseen data during training and store the fitness values obtained as (f₂).

Further, at step 208, using any memetic based iterative search method such as Genetic Algorithm, Particle Swann optimization, Simulated Annealing, etc. multiple models can be built. The input population for these methods will be output from Step 206. Then variants of different models are generated over multiple generations as per the memetic algorithms approach to search for better solutions. The search is repeated over multiple iterations until a termination condition such as numbers of iterations/convergence conditions are met. The final population that is obtained is passed on to the next step.

Further, at step 210, both the fitness functions (f₁) and (f₂) for the various models are compared using Pareto front, which would select the best performing models, not only on the training data but also on unseen data that is testing data. Based on the conducted comparison on Pareto front, the best performing models can be selected, wherein the best performing models are representative population of best generalization to the data set provided.

Further, at step 212, the evaluation of the same or different fitness function for the best performing models is repeated using the left out data sets (p₃) and (p₄), as both (p₁) and (p₂) have been used in generating and/or updating the model, neither is a true representation of the validation data, and both (p₃) and (p₄) have never been utilized until this point. The fitness value of the best performing models is stored as (f₃) and (f₄).

Further, at step 214, multi-objective optimization is used to select and rank the best performing models and output the best models using the value of the fitness functions.

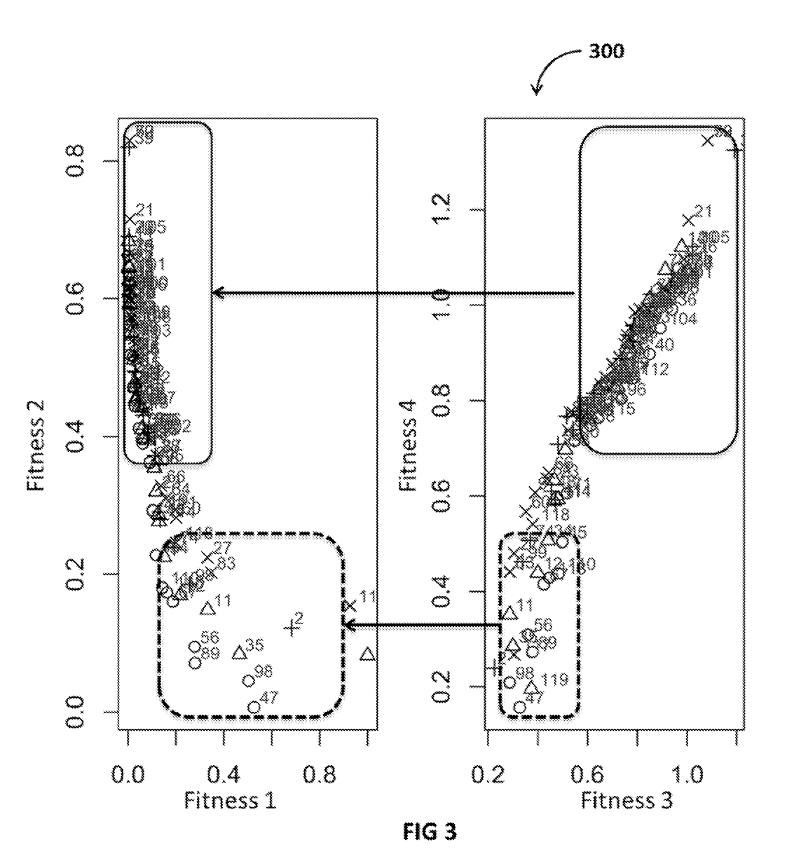

FIG. 3 is a schematic diagram 300 illustrating a use case of validation and selection of best performing models by plotting fitness functions of multiple models over Pareto front for evaluation, according to an embodiment herein. The Goldstein Price function is used to generate synthetic data it is parameterized to have 21 coefficients that are the variables to be estimated. Additionally it is also modified to add a noise component to simulate noise in input data sets. The function is defined as:

f(x)=[a₁+a₂₀(a₂+a₃x₁+a₄x₂)²(a₅−a₆x₁+a₇x₁²−a₈x₂a₉x₁x₁+a₁₀x₂²)]×[a₁₁+a₂₁(a₁₂x₁−a₁₃x₂)²(a₁₄−a₁₅x₁+a₁₆x₁²+a₁₇x₂−a₁₈x₁x₂+a₁₉x₂²)]+δₙₒᵢₛₑ

A total of 1000 samples were selected as dataset input to the modeling method, which is further split into 4 parts of equal size. The different test functions were selected as the squared error with the objective to minimize the error. Further, 500 initial solutions were generated based on different initial parameter estimates in the range of [0, 1]. These solutions were then passed on to a Genetic Algorithm for a total of 100 iterations to minimize f₁ using p₁ over these iterations. At the end of 100 generations of the genetic algorithm, the solutions obtained are ranked based on f₁ and f₂. The best performing solutions are then revaluated on the f₃ and f₄ using p₃ and p₄ respectively. The plots are generated using normalized outputs for the fitness values for easier interpretation.

If a standard optimization method were used on the data set using p₁, then the best performing solutions have close to 0 fitness values for f₁. However, from the plot, it can be seen that these have a relatively high values, i.e. inferior performance on all f₂, f₃ and f₄ clearly indicating over fitting on data. The best possible solutions have a slightly higher f₁, which also perform equally on the validation data sets on f₂, f₃ and f₄.

Further, from the diagram 300, it is also observed that the over fitted models that have a low Fitness₁ (f₁) are clearly having higher errors in Fitness₂ (f₂) and also in both Fitness₃ (f₃) and Fitness₄ (f₄). The best models that performed equally well in Fitness₂ (f₂), Fitness₃ (f₃) and Fitness₄ (f₄) are the ones that have a slightly higher Fitness₁ (f₁), which would be rejected by standard optimization methods.

Further, from the Pareto front plotting, it can be observed that Spread of the solutions on f₁ axis will denote if the models could have been over fitted. A wide range of distribution will denote over fitting on training data. Further, it can be observed that stronger distribution of solutions on the left extreme on f₁ and top of f₂ denotes the set of the solutions that have been over fitted and perform poorly on the validation data p₂ Further, it can be observed that the range of distribution of selected good solutions on f₂ in comparison with their respective spread on f₃ and f₄ will denote if the generated models have a good generalization of the data provided. If the spreads are nearly similar then, the models have accurately modeled the underlying patterns in the input data. However, if the spread on f₃ and f₄ is much larger, it indicates that there has been no good generalization or global optima solutions that have been found.

Consider an embodiment of pseudo modeling method describing the method for automated model building, validation and selection of best performing models. According to the pseudo modeling method, at step 1, complete input data is defined with m variables and n samples, wherein the complete input data can be a dataset obtained from one or more external data sources.

Further, at step 2, n samples from the received input data can be split into four parts: n₁, n₂, n₃ and n₄, wherein n=n₁+n₂+n₃+n₄. Further, the first part of the input data n₁ can be defined as training data, the second part of the input data n₂ can be defined as testing data, the third and fourth parts of the input data can be defined as validation data part 1 and validation data part 2 respectively. In an embodiment of the present invention, the four parts n₁, n₂, n₃ and n₄ of the input data are split in equal parts.

Further, at step 3, multiple templates of modeling methods can be define from a universal set of modeling methods that can be used for the current data and optimization method. Of all the available modeling methods available, k different modeling methods can be selected for modeling for the obtained input data: Sₖ⊂S.

Further, at step 4, each selected template is used to create multiple different variants of modeling approach on the selected data set based on the selection of samples used for training, variables selected for training and modeling method variable parameters. Each variant of a modeling method can be defined as a function as:

Mdlⱼ=f(Sampₙ₁,Varₙ₁,Sₖ,Par_{S}), wherein

Sampₙ₁ is subset of n₁ rows,
Varₙ₁ is subset of n₁ columns,
Sₖ is the selected modeling method, and
Par_{Sk} is the set of modeling method variable parameters.

Further, the selection process can be repeated and D number of templates can be generated defined as:

Models={Mdl₁,Mdl₂, . . . Mdl_{D}}

Further, at step 5, the performance of all the models can be assessed based on the two different fitness functions defined as:

F₁ⱼ=fitₐ(Mdlⱼ,n₁); and

F₂ⱼ=fit_{b}(Mdlⱼ,n₂), wherein

fitₐ and fit_{b} are performance metrics selected for the current problem. According to an embodiment of the present invention, it is not necessary that fitₐ and fit_{b} need to be similar definition and/or of same scale.

Further, at step 6, an optimization method can be optionally run using either/both F₁ⱼ and F₂ⱼ to generate better solutions by varying the different input parameters to each Model Mdlⱼ defined in Step #4. The final solution set from the optimization method will have the best possible fitness that can be obtained on F₁ⱼ and/or F₂ⱼ.

Further, at step 7, the models obtained can be ranked using multi-objective optimization on F₁ⱼ and F₂ⱼ. Each model is given a single valued fitness as:

TestFitⱼ=#[(F₁ⱼ,F₂ⱼ) [symbol] ∪{(F₁₁,F₂₁),(F₁₂,F₂₂), . . . , (F_{1D},F_{2D})}]

Which is defined as the count of solutions the selected model j dominates in the set of all models obtained from 1 to D.

Further, the models can be ranked in descending order of TestFitⱼ and select the top P solutions for next step.

Further, at step 8, the models obtained from above step can be revaluated using the data parts n3 and n4 to get the validation fitness using the fitness functions defined as:

F₃ⱼ=fit_{c}(Mdlⱼ,n₃);

F₄ⱼ=fit_{d}(Mdlⱼ,n₄), wherein

fit_{c} and fit_{d} are performance metrics selected for the current problem. In an embodiment of the present invention, it is not necessary that fitₐ, fit_{b}, fit_{c} and fit_{d} need to be similar definition and/or of same scale.

Further, at step 9, the models obtained using multi-objective optimization can be ranked based on F₃ⱼ and F₄ⱼ. Each model is given a single valued fitness as:

ValFitⱼ=#[(F₃ⱼ,F₄ⱼ) [symbol] ∪{(F₃₁,F₄₁),(F₃₂,F₄₂), . . . ,(F_{3D},F_{4D})}]

Which is defined as the count of solutions the selected model j dominates in the set of all models obtained from 1 to D.

Further, the models can be ranked in descending order of ValFitⱼ and the top Q solutions can be selected as final output.

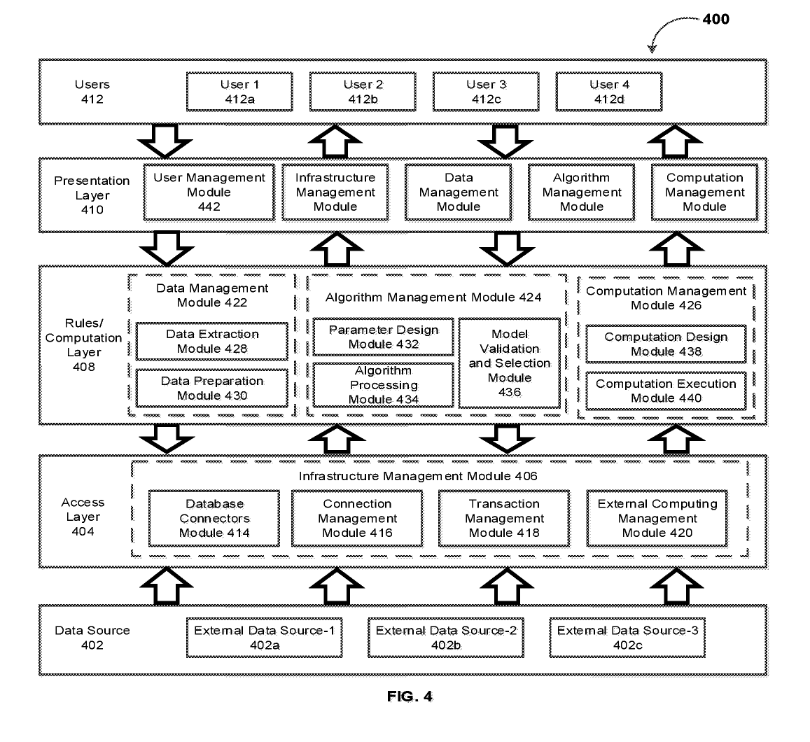

FIG. 4 is a block diagram 400 illustrating a system for automated model building, validation and selection of best performing models, according to an embodiment herein. The system comprises of a data source 402, an access layer 404, a rules/computation layer 408, a presentation layer 410, and one or more users user 1 (412a), user 2 (412b), user 3 (412c), and user 4 (412d).

Further, the access layer 404 comprises of an infrastructure management module 406, wherein the infrastructure management module 406 comprises of a database connector module 414, a connection management module 416, a transaction management module 418, and an external computing management module 420. The rules/computation layer 408 of the system 400 comprises of a data management module 422, an algorithm management module 424, and a computation management module 426. The data management module 422 further comprises of a data extraction module 428 and a data preparation module 430. The algorithm management module 424 further comprises of a parameter design module 432, an algorithm processing module 434, and a model validation and selection module 436. The computation management module 426 further comprises of a computation design module 438 and a computation execution module 440. The presentation layer 410 comprises of user management module 442.

According to the present invention, the data source 402 provides a vast dataset for modeling. In an embodiment of the present invention, the data source 402 can comprise of a single data source that consist of plurality of dataset. In another embodiment of the present invention, the data source 402 comprise of one or more external data sources, external data source-1 402a, external data source-2 402b, external data source-3 402c, and the like. The datasets obtained from various external data sources can be used together for modeling. In an embodiment of the present invention, the external data sources external data source-1 402a, external data source-2 402b, external data source-3 402c can be any of the data sources, such as, but not limited to, cloud storage, database servers, flat files and the like, and the person having ordinarily skilled in the art can understand that any of the known data sources can be used for providing datasets, without departing from the scope of the invention.

The infrastructure management module 406 of the access layer 404 allows the user to manage and monitor the different types of infrastructures that can be used by the system 400 for its functioning. Using the infrastructure management module 406, the system 400 can be connected to other external systems or modules to execute various functions depending on the type and size of the data to be handled. In some instances, the system 400 can connect with other external systems to execute modeling methods and receive outputs, without departing from the scope of the invention.

The database connector module 414 of the infrastructure management module 406 enables users to connect to various external data sources, external data source-1 402a, external data source-2 402b, and external data source-3 402c, of different types from where the data for model building can be obtained. The database connector module 414 receives the data from one or more external data sources and connects them to form a single data set. The database connector module 414 works in conjunction with the connection management module 416.

The connection management module 416 of the infrastructure management module 406 works in conjunction with all other modules and is the core module for managing the connection of system 400 with all external systems. In an embodiment of the present invention, the external systems includes, but not limited to, external applications from where raw data will be extracted, cloud based systems that might be used to provide external computation resources to run modeling method in case of large datasets, and the like, without departing from the scope of the invention.

The transaction management module 418 of the infrastructure management module 406 manages all transactions within the system 400 and with external systems, wherein the transactions can include, but not limited to, security authentication, query management, data movement, and the like, without departing from the scope of the invention.

Further, there can be scenarios where large datasets are involved and thus a need to use external computing resources to execute modeling methods might arise to increase efficiency and reduce time for processing of the dataset. The external computing management module 420 manages all external computing whether they exist on other hardware or virtually in the cloud, and thereby helping in reducing time for processing of datasets.

Further, the rules/computing layer 408 of the system 400 comprise of the data management module 422, the algorithm management module 424, and the computation management module 426.

The system can have various types of data that need to be managed, system data, raw data, processed data, and the like. System data is the data intrinsic to the system 400 and is running like user data, Job data, fitness selection, modeling method templates, and the like. Raw data is data received by the system 400 from one or more external sources and pertains to model building. Processed data is the data created from the raw data that will be used as inputs for the modeling methods and can also be data of the results obtained after the modelling methods are run. The data management module 422 handles management of various types of data of the system 400.

The data extraction module 428 of the data management module 422 deals with the extraction of data from one or more external sources that will be used as raw data. The data extraction module 428 can run in conjunction with the database connector module 414.

The data preparation module 430 of the data management module 422 enables processing of the raw data and can enable the execution of various tasks, such as, but not limited to, error identification and correction, dataset splitting based on the needs of the scientist, identification of best input data, synthetic data creation, and the like, without departing from the scope of the invention.

The algorithm management module 424 of the rules/computation layer 408 helps the system 400 with identifying and selection of one or more suitable modeling methods for the problem to be solved. Based on the problem to be solved for creating models, various types of modelling techniques such as, but not limited to, Random Forest, SVM, J48, and the like can be identified that user might want to use. The algorithm management module 424 also helps in deciding what input data can be used to run the modules, wherein the input data is received from the data management module 422. Further, the algorithm management module 424 helps in deciding on various parameters against which the modelling method will be run, for example, number of trees in a decision tree method. Further, the algorithm management module 424 also defines the fitness parameters against which the model performance can be measured with respect to solving the problem.

The parameter design module 432 of the algorithm management module 424 takes care of the design of all input and output parameters like input data, modelling method parameters and fitness design parameters. Further, the algorithm processing module 434 of the algorithm management module 424 works in conjunction with the computation management module 426 and enables the start and end of the running of the various modeling methods and their variants. Further, the model validation and selection module 436 is the core module of the system 400, wherein after all the various modelling methods and their variants are executed, the results obtained are used by the model validation and selection module 436 to obtain the best fit based on the fitness parameters plotted on the Pareto front.

Further, the rules/computation layer 408 comprises of the computation management module 426 that helps in managing the computation needs of the system 400. It is expected that at any given time, many functions of the system 400 can be working simultaneously, and the simultaneous functions should be provided with necessary optimum computation resources. The computation management module 426 manages the computation resources needed for managing the functions of the system 400.

The computation design module 438 of the computation management module 426 enables the prioritisation of computation needs based on the size of computation in terms of infrastructure and time. The computation design module 438 also enables the user to decide whether the computation should be done internally with system resources or through an externally available resource like cloud computing. Further, the computation design module 438 also manages the computing queues based on computing requirements, without departing from the scope of the invention.

Once the computing queues are finalised, the computation execution module 440 manages the execution of the queues. Through the computation execution module 440, the user can also handle errors to ensure smooth execution of the jobs.

The presentation layer 410 of the system 400 handles presenting of the data and the results obtained from computation to the one or more users user 1 412a, user 2 412b, user 3 412c, and user 4 412d. The presentation layer 410 comprises of the user management module 442, wherein the user management module 442 primarily manages the various kinds of users, user 1 412a, user 2 412b, user 3 412c, and user 4 412d, that will be accessing the system 400. Different users will use the system 400 to manage various functions right from data management to infrastructure management.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. An automated method of generating and selecting models, the method comprising steps of:
selecting, by a data extraction module, a dataset available for modeling from one or more external data sources;
preparing, by the data preparation module data for modeling by processing the raw data obtained from one or more external data sources as per the requirements of the scientist/modeler;
dividing, by a data management module, the prepared dataset into at least three parts;
selecting, by an algorithm management module, one or more modeling methods along with associated parameters ranges based on the model to be built;
identifying, by a parameter design module, one or more fitness functions against which the models need to be evaluated;
generating, by the algorithm management module, a plurality of model building experiment variation that can be run utilizing a first part of the dataset;
obtaining, by an algorithm processing module values of the fitness function for the different modeling method experiments on the first part of the dataset;
obtaining, by the algorithm processing module, the value of the same or different second fitness function by running the generated models from the different experiments on a second part of the dataset to evaluate the model performance on unseen data during training;
selecting, by a model validation and selection module, one or more best performing models by comparing the first fitness value and the second fitness value;
generating, by the algorithm processing module, values of the same or different fitness function using selected one or more best performing models on the remaining datasets; and
comparing, by a model validation and selection module, the various fitness functions to select the best model.

2. The method of claim 1, wherein the dataset is obtained by merging data from one or more external data sources using a database connector module.

3. The method of claim 1, wherein the first part of the dataset is training data.

4. The method of claim 1, wherein the second part of the dataset is testing data.

5. The method of claim 1, wherein the third and more parts of the dataset comprises of the validation data.

6. The method of claim 1, wherein the model is selected using Pareto front.

7. The method of claim 1, wherein the selection of best performing model is performed iteratively to obtain one or more best performing models.

8. An automated system for generating and selecting models, the system comprises of:
a database connector module that creates a dataset by receiving data from one or more external data sources and merging them;
a data extraction module that selects the dataset available for modeling from one or more external data sources;
a data preparation module that processes the raw data for modeling based on requirements;
a data management module that divides the dataset into at least three parts;
an algorithm management module adapted for:
selecting one or more modeling methods based on the model to be built;
generating a plurality of model building experiment variation that can be run utilizing a first part of the dataset;
a parameter design module adapted for:
designing algorithm parameters, input data parameters, and fitness function design parameters;
an algorithm processing module adapted for:
obtaining the value of the fitness function by running different modeling method experiments on the first part of the dataset and evaluating their final performance for each of the runs;
obtaining by the algorithm processing module the value of the same or different fitness function by running the generated models from the different experiments on the second part of the dataset to evaluate the fitness on unseen data during training; and
a model validation and selection module adapted for:
selecting one or more best performing models by comparing the first fitness value and the second fitness values;
obtaining the same or different fitness function by using the algorithm processing module to run the selected one or more best performing models on the remaining validation dataset; and
evaluating the one or more best performing models using the various fitness functions in phases to select the best model.

9. One or more computer-readable media having computer-usable instructions stored thereon for performing a method of the automated selection of models, the method comprising steps of:
selecting, by a data extraction module, a dataset available for modeling from one or more external data sources;
preparing, by a data preparation module, the modeling dataset by processing the raw data as per requirements of the scientist
dividing, by a data management module, the dataset into at least three parts;
selecting, by an algorithm management module, one or more modeling methods along with associated parameters ranges based on the model to be built;
generating plurality of model building experiment variation that can be run utilizing a first part of the dataset;
identifying, by a parameter design module, one or more fitness functions against which the models need to be evaluated;
obtaining, by an algorithm processing module, the value of the fitness function by running different modeling method experiments on the first part of the dataset and evaluating their final performance for each of the runs;
obtaining, by the algorithm processing module, the value of the same or different fitness function by running the generated models from the different experiments on a second part of the dataset to evaluate the fitness on unseen data during training;
selecting, by a model validation and selection module, one or more best performing models by comparing the first fitness value and the second fitness value;
obtaining, by the algorithm processing module, value of the same of different fitness function by running one or more best performing models on the remaining validation dataset; and
evaluating, by the model validation and selection module, one or more best performing models by comparing the values of the various fitness functions to select the best model.
